(19) United States
(12) Patent Application Publication
(10) Pub. No.: US 2025/0130127 A1
(43) Pub. Date: Apr. 24, 2025

(54) METHOD AND SYSTEM FOR ANALYZING THE PRESS-FITTING CURVE OF AMERICAN STANDARD WHEELSET

(71) Applicant: TAIYUAN HEAVY INDUSTRY RAILWAY TRANSIT EQUIPMENT CO., LTD., Taiyuan City (CN)

(72) Inventors: Xinglong ZHAO, Taiyuan City (CN); Jianzhong LEI, Taiyuan City (CN); Xianhe JIN, Taiyuan City (CN); Huacheng WEI, Taiyuan City (CN); Zhiwei SONG, Taiyuan City (CN); Zhiwei LEI, Taiyuan City (CN)

(73) Assignee: TAIYUAN HEAVY INDUSTRY RAILWAY TRANSIT EQUIPMENT CO., LTD., Taiyuan City (CN)

(21) Appl. No.: 18/973,727

(22) Filed: Dec. 9, 2024

Related U.S. Application Data
(63) Continuation-in-part of application No. PCT/CN2024/087133, filed on Apr. 11, 2024.

(30) Foreign Application Priority Data
Oct. 24, 2023 (CN) 202311385138.3

(51) Int. Cl. G01L 5/00; B60B 37/04

(52) U.S. Cl. CPC G01L 5/00; B60B 37/04

(57) ABSTRACT

A method and system for analyzing the press-fitting curve of American standard wheelset includes: acquiring American standard wheelset parameters, press-fitting parameters and pressure data, and establishing a wheelset press-fitting curve; acquiring a plurality of judgment items on the established curve, and analyzing the acquired judgment items according to a preset algorithm to obtain an analysis result, which can analyze all the curves of the end points, wave peaks, wave troughs, ascending and descending sections of the wheelset press-fitting curve. The method is simple to operate and convenient to use, and can automatically and accurately determine whether the curve meets the requirements. At the same time, the identification and determination of unqualified items of the curve provide a basis for the quality improvement of the subsequent press-fitting process, which promotes the quality improvement of wheelset press-fitting, avoids product repair, and further improves the press-fitting efficiency.

### TECHNICAL FIELD

The present application relates to the technical field of railway vehicle wheelset press-fitting, in particular to a method and system for analyzing the press-fitting curve of American standard wheelset.

### BACKGROUND

Wheelset is the key component of running gear of railway vehicles, and its press-fitting quality is directly related to the running safety of vehicles. Generally, the wheels are press-fitted to the axle, and the press-fitting curve is generated according to the actual situation during the press-fitting process, which is mainly used to determine the press-fitting quality of the wheelset.

At present, the wheelset press-fitting equipment can only judge the simple judgment items of the wheelset press-fitting curve, and there is no accurate judgment solution for wheelset press-fitting curve. The press-fitting curve of American standard wheelset mainly depends on manual judgment, and the omission and misjudgment occasionally occur.

### SUMMARY

In order to solve some or all of the technical problems in the prior art, the present application provides a method and a system for analyzing the press-fitting curve of American standard wheelset. The method is simple to operate and convenient to use, and can automatically and accurately judge whether the curve meets the requirements. At the same time, the identification and judgment of unqualified items of the curve provide a basis for the quality improvement of the subsequent press-fitting process, which promotes the quality improvement of wheelsets, avoids product repair, and further improves the press-fitting efficiency.

In a first aspect, the present application provides a method for analyzing the press-fitting curve of American standard wheelset, including:
a step of establishing a wheelset press-fitting curve: acquiring American standard wheelset parameters, press-fitting parameters and pressure data, and establishing a wheelset press-fitting curve, wherein the original data of the wheelset press-fitting curve is pressure-displacement data automatically generated in a press-fitting process, which is expressed as F(S)={(F₁,S₁), (F₂,S₂), . . . , (Fᵢ,Sᵢ), . . . , (Fₙ,Sₙ)}, where i=1, 2, . . . , n, (Fᵢ,Sᵢ) represents that the pressure (press-fitting force) is Fᵢ when the relative displacement between the wheel and the axle during the press-fitting process is Sᵢ, and the length of the wheelset press-fitting curve is Sₙ;
a step of system analysis: analyzing several judgment items of the established wheelset press-fitting curve, and determining whether the wheelset press-fitting curve meets requirements based on whether each judgment item meets a corresponding preset algorithm, wherein, when analyzing the wheelset press-fitting curve, the judgment items and the corresponding preset algorithm of the judgment items are as follows:
an actual maximum press-fitting force: F max=MAX(Fᵢ)<F MAX;
an end point pressure: F_{f}=Fₙ>F MIN;
a pressure stable section: the pressure stable section is a length range after an initial pressure section until an end point of the curve, where the initial pressure section is 0<Sᵢ<25%×Sₙ, and the pressure stable section is 25%×Sₙ≤Sᵢ≤Sₙ, and in the pressure stable section, a pressure difference between adjacent points is |Fᵢ₊₁−Fᵢ|≤20KN;
a pressure rising section: the pressure rising section is a length range after the initial pressure section until a maximum press-fitting force on the wheelset press-fitting curve, and in the pressure rising section, the press-fitting force gradually rises without decrease, that is, 25%×Sₙ≤Sᵢ≤Sⱼ, Fᵢ₊₁-Fᵢ≥0, Fⱼ=F max, i+1≤j;
an entry pressure peak: the entry pressure peak refers to a maximum pressure in a process of steep pressure rise to force drop in the initial pressure section, that is, within the range of 0<Sᵢ<25%×Sₙ in the initial pressure section, Fᵢ>Fᵢ₊₁, Fᵢ>Fᵢ₋₁, and Fᵢ≤30 US tons;
an entry force drop: the entry force drop is a decreased value of the press-fitting force in the initial pressure section from the entry pressure peak to the pressure rising section, and the entry pressure peak is not more than 3 times the entry force drop, that is, 0<Sᵢ<Sⱼ<25%×Sₙ, Fᵢ>Fᵢ₊₁, Fᵢ>Fᵢ₋₁, Fᵢ>Fⱼ, Fᵢ≤3×(Fᵢ−Fⱼ);
a terminal force drop range: the terminal force drop range is a length range after the maximum press-fitting force on the wheelset press-fitting curve to the end point of the curve, and the terminal force drop range is within 25% of a terminal of the curve, that is, Sᵢ>75%×Sₙ, Fᵢ=F max;
a terminal pressure: the terminal pressure is a pressure within a range of 25% of the terminal of the curve, and the terminal pressure is greater than a theoretical minimum press-fitting force, that is, 75%×Sₙ<Sᵢ≤Sₙ, Fᵢ>F MIN;
a wheelset press-fitting curve characteristic template: the wheelset press-fitting curve characteristic template is constructed according to a length of the wheelset press-fitting curve, a theoretical maximum press-fitting force and a theoretical minimum press-fitting force related to the wheelset to be judged, and the wheelset press-fitting curve should be located in the wheelset press-fitting curve characteristic template;
a step of result display: the relevant information of the judged wheelset, the judgment result of each judgment item and the comprehensive judgment result of the wheelset press-fitting curve are displayed, and the curve graph is displayed, so as to determine whether the wheelset press-fitting curve is qualified or not and to identify the unqualified items; and
a step of applying the judgment result of each judgment item of the wheelset press-fitting curve to adjust the wheelset press-fitting equipment for a subsequent press fitting, so as to ensure the wheelset press-fitting quality and improve the press-fitting efficiency by adjusting the unqualified item to be qualified,
wherein, F max is the actual maximum press-fitting force, MAX(Fi) is a maximum of pressure values at any position i after a starting point on the wheelset press-fitting curve, F MAX is a theoretical maximum press-fitting force, F MIN is a theoretical minimum press-fitting force, F_{f} is the end point pressure, Sᵢ is the relative displacement of the wheel and the axle at position i on the wheelset press-fitting curve, and Fᵢ is the pressure at position i on the wheelset press-fitting curve, Sᵢ₊₁ is the relative displacement of the wheel and the axle at any i+1 position after the i position on the wheelset press-fitting curve, Fᵢ₊₁ is the pressure at any i+1 position after the i position on the wheelset press-fitting curve, Sⱼ is the relative displacement of the wheel and the axle at any j position after the i position on the wheelset press-fitting curve, Fⱼ is the pressure at any j position after the i position on the wheelset press-fitting curve, and Fₙ is the pressure at the end point Sₙ of the wheelset press-fitting curve.

Further, in the above method for analyzing the press-fitting curve of American standard wheelset, the obtained wheelset parameters comprise a wheelset product model, a theoretical maximum press-fitting force, a theoretical minimum press-fitting force, a wheel seat diameter, a press-fitting direction in which the wheel is pressed on the axle, an axle number and a wheel number.

Further, in the above method for analyzing the press-fitting curve of American standard wheelset, for a wheelset with a given press-fitting force range, the theoretical maximum press-fitting force F MAX and the theoretical minimum press-fitting force F MIN are directly set according to the given range; for a wheelset with no given press-fitting force range, a maximum press-fitting force coefficient and a minimum press-fitting force coefficient are set, and then the theoretical maximum press-fitting force F MAX and the theoretical minimum press-fitting force F MIN are calculated according to the maximum and minimum press-fitting force coefficients and a wheel seat diameter.

Further, in the above method for analyzing the press-fitting curve of American standard wheelset, when judging and analyzing the terminal pressure, the pressure within a range of 20%-30% of the terminal of the curve is greater than the theoretical minimum press-fitting force.

In a second aspect, the present application further provides a system for analyzing the press-fitting curve of American standard wheelset, including:
a wheelset press-fitting curve establishing module configured for acquiring American standard wheelset parameters, press-fitting parameters, pressure data and establishing a wheelset press-fitting curve;
a result analysis module configured for analyzing a plurality of judgment items of the established wheelset press-fitting curve, and judging whether the wheelset press-fitting curve meets requirements according to whether each judgment item meets a corresponding preset algorithm; and
a result display module configured for displaying the relevant information of the judged wheelset, the judgment result of each judgment item, the comprehensive judgment result of the wheelset press-fitting curve, and the curve graph, so as to determine whether the wheelset press-fitting curve is qualified or not, identify the unqualified items, and adjust the wheelset press-fitting equipment for a subsequent press fitting, so as to ensure the wheelset press-fitting quality and improve the press-fitting efficiency by adjusting the unqualified item to be qualified.

The method and the system for analyzing the press-fitting curve of American standard wheelsets have the following advantages and beneficial effects:

The present application establishes a wheelset press-fitting curve by acquiring American standard wheelset parameters, press-fitting parameters and pressure data; nine judgment items on the established wheelset press-fitting curve, including maximum pressure, terminal pressure, pressure stability, pressure rise, entry pressure peak, entry force drop, terminal force drop range, terminal pressure and curve characteristics, are analyzed, and whether the wheelset press-fitting curve meets the requirements is judged according to whether each judgment item meets the corresponding preset algorithm. Only when all judgment items meet the requirements, the wheelset press-fitting curve is qualified; otherwise the wheelset press-fitting curve is unqualified. The method and the system for analyzing the American standard wheelset press-fitting curve are simple to operate, all special inflection points, end points, critical points and vertices on the wheelset press-fitting curve are analyzed, and the line segments on both sides of the special points, such as the stable section and the rising section, are comprehensively analyzed correspondingly, so that the solution of the present application analyzes and studies the whole wheelset press-fitting curve; through parameterized judgment, the required data is input into the judgment module or the control module for judgment and processing, and the processing result is directly output, which is convenient to use and can automatically and accurately judge whether the curve meets the requirements; at the same time, the identification and judgment of the unqualified items of the curve provide a basis for the quality improvement of the subsequent press-fitting process, which promotes the quality improvement of wheelset press-fitting, avoids product repair, and further improves the press-fitting efficiency.

### BRIEF DESCRIPTION OF DRAWINGS

The accompanying drawings illustrated here are intended to provide a further understanding of the embodiments of the present application and constitute a part of the present application. The illustrative embodiments of the present application and their descriptions are used to explain the present application, and do not unduly limit the present application. In the attached drawings:

FIG. 1 is a flow chart of a method for analyzing the press-fitting curve of American standard wheelset of the present application;

FIG. 2 is a schematic diagram of a flow used for the method for analyzing an American standard wheelset press-fitting curve according to an embodiment of the present application;

FIG. 3 is a schematic diagram of a curve characteristic template of the method for analyzing the press-fitting curve of American standard wheelset according to an embodiment of the present application;

FIG. 4 is a schematic diagram for analyzing the characteristics of the actual wheelset press-fitting curve by the method for analyzing an American standard wheelset press-fitting curve according to an embodiment of the present invention.

### DESCRIPTION OF EMBODIMENTS

In order to make the purpose, technical solution and advantages of the present invention more clear, the technical solution of the present invention will be described clearly and completely with specific embodiments of the present invention and corresponding drawings. Obviously, the described embodiment is only a part of the embodiment of the present invention, not the whole embodiment. Based on the embodiment of the present invention, all other embodiments obtained by ordinary technicians in the field without creative labor belong to the scope of protection of the present invention.

It should be noted that the method and system for analyzing the press-fitting curve of American standard wheelset are mainly developed based on the requirements of AAR G-II “MANUAL OF STANDARDS AND RECOMMENDED PRACTICES SECTION WHEEL AND AXLE MANUAL”, can realize automatic and accurate judgment of wheelset press-fitting curve while meeting the judgment requirements of the manual, and can accurately judge whether the curve is qualified or not and the reasons of unqualified items so as to ensure the quality of wheelset press-fitting. The wheelset may be, for example, AAR-E wheelset, AAR-K wheelset and AAR-G wheelset.

### Example 1

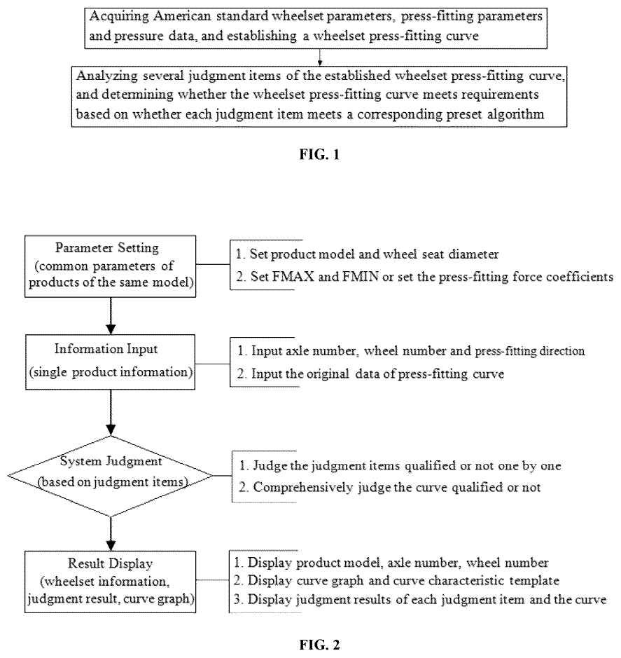

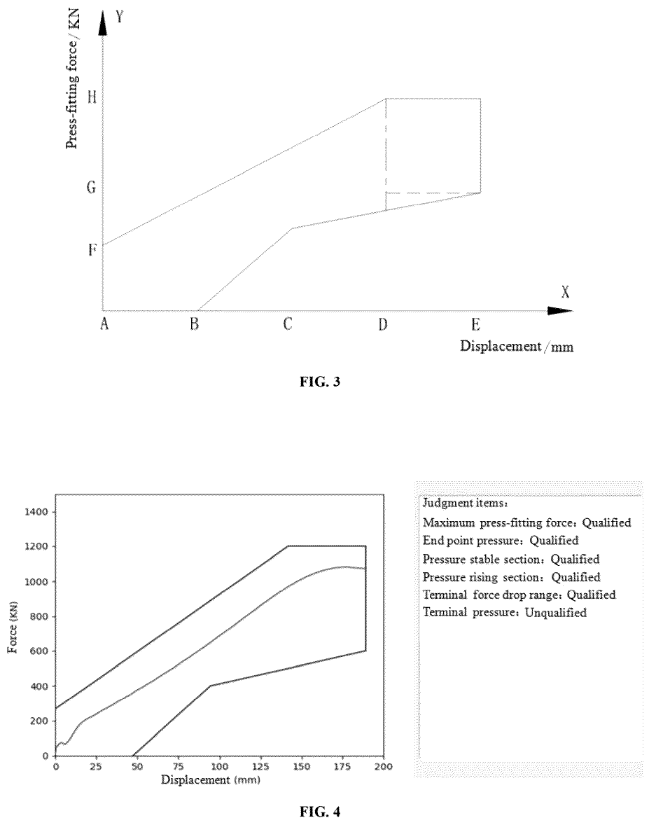

As shown in FIGS. 1-4, an embodiment of the present invention provides a method for analyzing the press-fitting curve of American standard wheelset, which includes: a step of establishing a wheelset press-fitting curve, acquiring American standard wheelset parameters, press-fitting parameters and pressure data, and establishing a wheelset press-fitting curve; a step of system analysis, analyzing several judgment items of the established wheelset press-fitting curve, and determining whether the wheelset press-fitting curve meets the requirements based on whether each judgment item meets the corresponding preset algorithm; a step of result display: the relevant information of the judged wheelset, the judgment result of each judgment item and the comprehensive judgment result of the wheelset press-fitting curve are displayed, and the curve graph is displayed, so as to determine whether the wheelset press-fitting curve is qualified or not and to identify the unqualified items; and a step of applying the judgment result of each judgment item of the wheelset press-fitting curve to adjust the wheelset press-fitting equipment for a subsequent press fitting, so as to ensure the wheelset press-fitting quality and improve the press-fitting efficiency by adjusting the unqualified item to be qualified. Wherein, the original data of the wheelset press-fitting curve is pressure-displacement data automatically generated in a press-fitting process, which is expressed as F(S)={(F₁,S₁), (F₂,S₂), . . . , (Fᵢ,Sᵢ), . . . , (Fₙ,Sₙ)}, where i=1, 2, . . . , n, (Fᵢ,Sᵢ) represents that the pressure is Fᵢ when the relative displacement between the wheel and the axle during the press-fitting process is Sᵢ, and the length of the wheelset press-fitting curve is Sₙ; the judgment items adopted on the wheelset press-fitting curve include: actual maximum press-fitting force, end point pressure, pressure stable section, pressure rising section, entry pressure peak, entry force drop, terminal force drop range, terminal pressure and wheelset press-fitting curve characteristic template.

As an embodiment of the present invention, taking AAR-E wheelset as an example, the judgment items obtained on the wheelset press-fitting curve and the corresponding preset algorithm of the judgment items include:

An actual maximum press-fitting force: the actual maximum press-fitting force on the wheelset press-fitting curve should be less than the theoretical maximum press-fitting force.

Specifically, the actual maximum press-fitting force represents the maximum pressure borne by the American standard wheelset, and the actual maximum press-fitting force on the wheelset press-fitting curve is less than the theoretical maximum press-fitting force, that is, F max=MAX(Fᵢ)<F MAX.
2) An end point pressure: the end point pressure on the wheelset press-fitting curve should be greater than the theoretical minimum press-fitting force.

Specifically, the end point pressure is the pressure of the end point of the wheelset press-fitting curve, which is greater than the theoretical minimum press-fitting force, that is, F_{f}=Fₙ>F MIN.
3) A pressure stable section: the pressure stable section is a length range after an initial pressure section until an end point of the curve, where the initial pressure section is 0<Sᵢ<25%×Sₙ, and the pressure stable section is 25%×Sₙ≤Sᵢ≤Sₙ, and on the pressure stable section, a pressure difference between adjacent points is |Fᵢ₊₁−Fᵢ|≤20KN.

In the wheelset press-fitting curve, the pressure should be stable except for the initial pressure section and this judgment item mainly detects whether there is a sharp rise in the curve caused by strain during the press-fitting process. Wherein, |Fᵢ₊₁−Fᵢ|≤20KN indicates that the difference between the last pressure value and the previous pressure value on the wheelset press-fitting curve is within the range of less than 20KN, which means that the pressure on the wheelset press-fitting curve is stable.
4) A pressure rising section: the pressure rising section is a length range after the initial pressure section until a maximum press-fitting force on the wheelset press-fitting curve, and within the pressure rising section, the press-fitting force gradually rises without decrease, that is, 25%×Sₙ≤Sᵢ≤Sⱼ, Fᵢ₊₁−Fᵢ≥0, Fⱼ=F max, i+1≤j.
5) An entry pressure peak: the entry pressure peak refers to a maximum pressure in a process of steep pressure rise to a force drop in the initial pressure section, that is, within the range of 0<Sᵢ<25%×Sₙ in the initial pressure section, Fᵢ>Fᵢ₊₁, Fᵢ>Fᵢ₋₁, and Fᵢ≤30 US tons.
6) An entry force drop: the entry force drop is a decreased value of the press-fitting force in the initial pressure section from the entry peak pressure to the pressure rising section, and the entry pressure peak is not more than 3 times the entry force drop, that is, 0<Sᵢ<Sⱼ<25%×Sₙ, Fᵢ>Fᵢ₊₁, Fᵢ>Fᵢ₋₁, Fᵢ>Fⱼ, Fᵢ≤3×(Fᵢ−Fⱼ).
7) A terminal force drop range: the terminal force drop range is a length range after the maximum press-fitting force on the wheelset press-fitting curve to the end point of the curve, and the terminal force drop range is required to be within 25% of a terminal of the curve, that is, Sᵢ>75%×Sₙ, Fᵢ=F max.
8) A terminal pressure: the terminal pressure is a pressure within a range of 20%-30% of the terminal of the curve, and the terminal pressure is greater than a theoretical minimum press-fitting force, and preferably, the terminal pressure is a pressure within a range of 25% of the terminal of the curve, that is, 75%×Sₙ<Sᵢ≤Sₙ, Fᵢ>F MIN.
9) A wheelset press-fitting curve characteristic template: the wheelset press-fitting curve characteristic template is constructed according to a length of the wheelset press-fitting curve, a theoretical maximum press-fitting force and a theoretical minimum press-fitting force related to the wheelset to be judged, and the wheelset press-fitting curve should be located in the wheelset press-fitting curve characteristic template.

In the above formula, F max is the actual maximum press-fitting force, MAX(Fi) is a maximum of pressure values at any position i after a starting point on the wheelset press-fitting curve, F MAX is a theoretical maximum press-fitting force, F MIN is a theoretical minimum press-fitting force, F_{f} is the end point pressure, Sᵢ is the relative displacement of the wheel and the axle at position i on the wheelset press-fitting curve, and Fᵢ is the pressure at position i on the wheelset press-fitting curve, Sᵢ₊₁ is the relative displacement of the wheel and the axle at any i+1 position after the i position on the wheelset press-fitting curve, Fᵢ₊₁ is the pressure at any i+1 position after the i position on the wheelset press-fitting curve, Sⱼ is the relative displacement of the wheel and the axle at any j position after the i position on the wheelset press-fitting curve, Fⱼ is the pressure at any j position after the i position on the wheelset press-fitting curve, and Fₙ is the pressure at the end point Sₙ of the wheelset press-fitting curve.

Specifically, after obtaining the American standard wheelset parameters, press-fitting parameters and pressure data, the press-fitting force setting mode is selected according to the given size of the press-fitting force: for wheelsets given the maximum and minimum press-fitting forces, the theoretical maximum press-fitting force F MAX and the theoretical minimum press-fitting force F MIN are directly set according to the given range and directly input as the obtained press-fitting parameters; for wheelsets without the maximum and minimum press-fitting forces, the maximum and minimum press-fitting force coefficients are set and then the theoretical maximum press-fitting force F MAX and the theoretical minimum press-fitting force F MIN are calculated according to the maximum and minimum press-fitting force coefficients and the wheel seat diameter.

Specifically, the obtained wheelset parameters include a wheelset product model, maximum and minimum press-fitting forces, a wheel seat diameter, a press-fitting direction in which the wheel is pressed on the axle, an axle number and a wheel number.

To sum up, when analyzing the curve characteristics, it includes analyzing all ascending, descending and horizontal line segments on the wheelset press-fitting curve, all inflection points, end points, critical points and stagnation points on the curve, as well as the actual maximum press-fitting force, end point pressure, pressure stable section, pressure rising section, entry pressure peak, entry force drop, terminal force drop range and terminal pressure on the wheelset press-fitting curve. A wheelset press-fitting curve characteristic template is generated according to the wheelset press-fitting curve length, a theoretical maximum press-fitting force and a theoretical minimum press-fitting force related to the wheelset to be judged, and the comparison result is displayed in the wheelset press-fitting curve characteristic template.

Therefore, by analyzing and comparing the numerical relationship of curve characteristics, all the end points, wave peaks, wave valleys, rising and falling sections on the wheelset press-fitting curve are analyzed, and the analyzed wheelset press-fitting curve results are more accurate, which can identify the items or line segments that do not meet the requirements more accurately and thus improve the quality of wheelset press-fitting.

### Example 2

The specific judgment process of the method for analyzing the press-fitting curve of American standard wheelset according to an embodiment of the present application includes information input, system analysis and result display.
1. Information input: the product model, maximum and minimum press-fitting force, wheel seat diameter, press-fitting direction in which the wheel is pressed on the axle, axle number and wheel number, wheelset press-fitting curve displacement and pressure data are input.
2. System analysis: through the analysis of nine judgment items, including actual maximum press-fitting force, end point pressure, pressure stable section, pressure rising section, entry pressure peak, entry force drop, terminal force drop range, terminal pressure and wheelset press-fitting curve characteristic template, it is judged whether each judgment item meets the requirements. When all the items meet the requirements, the press-fitting curve of American standard wheelset is qualified; otherwise the press-fitting curve of American standard wheelset is unqualified.
3. Result display: the relevant information of the judged wheelset, the judgment result of each judgment item and the comprehensive judgment result of the wheelset press-fitting curve are displayed, and the curve graph is displayed. The wheelset press-fitting curve graph is displayed on the lower left of the system interface, related information of the wheelset and comprehensive judgment results are displayed on the upper part of the curve graph, and all judgment items and judgment results are displayed on the right side of the curve graph.

FIG. 4 shows a schematic diagram of judging the actual wheelset press-fitting curve by the method of the present invention, in which the area enclosed by the straight lines is the wheelset press-fitting curve characteristic template, the curve located within the wheelset press-fitting curve characteristic template is the wheelset press-fitting curve, and the part displayed on the right side of FIG. 4 is the judgment result.

### Example 3

The present application further provides a system for analyzing the press-fitting curve of American standard wheelset, which includes:
a wheelset press-fitting curve establishing module configured for acquiring American standard wheelset parameters, press-fitting parameters, pressure data and establishing a wheelset press-fitting curve; and
a result analysis module configured for analyzing a plurality of judgment items of the established wheelset press-fitting curve, and judging whether the wheelset press-fitting curve meets requirements according to whether each judgment item meets a corresponding preset algorithm; and
a result display module configured for displaying the relevant information of the judged wheelset, the judgment result of each judgment item, the comprehensive judgment result of the wheelset press-fitting curve, and the curve graph, so as to determine whether the wheelset press-fitting curve is qualified or not, identify the unqualified items, and adjust the wheelset press-fitting equipment for a subsequent press fitting, so as to ensure the wheelset press-fitting quality and improve the press-fitting efficiency by adjusting the unqualified item to be qualified.

In some alternative implementations of this embodiment, the obtained wheelset parameters include a wheelset product model, maximum and minimum press-fitting forces, a wheel seat diameter, a press-fitting direction in which the wheel is pressed on the axle, an axle number and a wheel number. The judgment items of the established wheelset press-fitting curve include actual maximum press-fitting force, end point pressure, pressure stable section, pressure rising section, entry pressure peak, entry force drop, terminal force drop range, terminal pressure and wheelset press-fitting curve characteristic template.

Therefore, through the analysis system for the American standard wheelset press-fitting curve, the comprehensive analysis of all line segments and inflection points, critical points, end points and vertices on the wheelset press-fitting curve is realized, so that the analysis of the curve is more comprehensive, thorough and accurate.

To sum up, the method and the system for analyzing the American standard wheelset press-fitting curve of the present application establish the wheelset press-fitting curve by obtaining the American standard wheelset parameters, press-fitting parameters and pressure data; nine judgment items on the established wheelset press-fitting curve, including actual maximum press-fitting force, end point pressure, pressure stable section, pressure rising section, entry pressure peak, entry force drop, terminal force drop range, terminal pressure and wheelset press-fitting curve characteristic template, are analyzed, and whether the wheelset press-fitting curve meets the requirements is judged according to whether each judgment item meets the corresponding preset algorithm. Only when all judgment items meet the requirements, the wheelset press-fitting curve is qualified; otherwise the wheelset press-fitting curve is unqualified.

The method and the system for analyzing the American-Standard wheelset press-fitting curve are simple to operate, all special inflection points, end points, critical points and vertices on the wheelset press-fitting curve are analyzed, and the line segments on both sides of the special points, such as the pressure stable section and the pressure rising section, are comprehensively analyzed correspondingly, so that the solution of the present application analyzes and studies the whole wheelset press-fitting curve, and by way of a parameterized judging mode, after inputting the required data into the result analysis module or judgment module for judgment and processing, the processing result is directly output, which is convenient to use and can automatically and accurately judge whether the curve meets the requirements. At the same time, the identification and judgment of the unqualified items of the curve provide a basis for the quality improvement of the subsequent press-fitting process, which promotes the quality improvement of wheelset press-fitting, avoids product repair, and further improves the press-fitting efficiency.

It should be noted that in this paper, relational terms such as “first” and “second” are only used to distinguish one entity or operation from another entity or operation, and do not necessarily require or imply that there is any such actual relationship or order between these entities or operations. Moreover, the terms “including”, “comprising” or any other variation thereof are intended to cover non-exclusive inclusion, so that a process, method, article or equipment including a series of elements includes not only those elements, but also other elements not explicitly listed or elements inherent to such process, method, article or equipment. In addition, the words “front”, “back”, “left”, “right”, “upper” and “lower” in this paper refer to the placement state shown in the attached drawings.

Finally, it should be explained that the above embodiments are only used to illustrate, rather than to limit the technical solution of the present application; although the present application has been described in detail with reference to the foregoing examples, those skilled in the art should understand that it is still possible to modify the technical solution described in the foregoing embodiments, or to replace some technical features with equivalents; however, these modifications or substitutions do not make the essence of the corresponding technical solutions deviate from the spirit and scope of the technical solutions of various embodiments of the present application.

What is claimed is:

1. A method for analyzing the press-fitting curve of American standard wheelset, including:
a step of establishing a wheelset press-fitting curve: acquiring American standard wheelset parameters, press-fitting parameters and pressure data, and establishing a wheelset press-fitting curve, wherein the original data of the wheelset press-fitting curve is pressure-displacement data automatically generated in a press-fitting process, which is expressed as F(S)={(F₁,S₁), (F₂,S₂), . . . , (Fᵢ,Sᵢ), . . . , (Fₙ,Sₙ)}, where i=1, 2, . . . , n, (Fᵢ,Sᵢ) represents that the pressure is Fᵢ when the relative displacement between the wheel and the axle during the press-fitting process is Sᵢ, and the length of the wheelset press-fitting curve is Sₙ;
a step of system analysis: analyzing several judgment items of the established wheelset press-fitting curve, and determining whether the wheelset press-fitting curve meets requirements based on whether each judgment item meets a corresponding preset algorithm, wherein, when analyzing the wheelset press-fitting curve, the judgment items and the corresponding preset algorithm of the judgment items are as follows:
an actual maximum press-fitting force: F max=MAX(Fᵢ)<F MAX;
an end point pressure: F_{f}=Fₙ>F MIN;
a pressure stable section: the pressure stable section is a length range after an initial pressure section until an end point of the curve, where the initial pressure section is 0<Sᵢ<25%×Sₙ, and the pressure stable section is 25%×Sₙ≤Sᵢ≤Sₙ, and in the pressure stable section, a pressure difference between adjacent points is |Fᵢ₊₁−Fᵢ|≤20KN;
a pressure rising section: the pressure rising section is a length range after the initial pressure section until a maximum press-fitting force on the wheelset press-fitting curve, and in the pressure rising section, the press-fitting force gradually rises without decrease, that is, 25%×Sₙ≤Sᵢ≤Sⱼ, Fᵢ₊₁−Fᵢ≥0, Fⱼ=F max, i+1≤j;
an entry pressure peak: the entry pressure peak refers to a maximum pressure in a process of steep pressure rise to force drop in the initial pressure section, that is, within the range of 0<Sᵢ<25%×Sₙ in the initial pressure section, Fᵢ>Fᵢ₊₁, Fᵢ>Fᵢ₋₁, and Fᵢ≤30 US tons;
an entry force drop: the entry force drop is a decreased value of the press-fitting force in the initial pressure section from the entry pressure peak to the pressure rising section, and the entry pressure peak is not more than 3 times the entry force drop, that is, 0<Sᵢ<Sⱼ<25%×Sₙ, Fᵢ>Fᵢ₊₁, Fᵢ>Fᵢ₋₁, Fᵢ>Fⱼ, Fᵢ≤3×(Fᵢ−Fⱼ);
a terminal force drop range: the terminal force drop range is a length range after the maximum press-fitting force on the wheelset press-fitting curve to the end point of the curve, and the terminal force drop range is within 25% of a terminal of the curve, that is, Sᵢ>75%×Sₙ, Fᵢ=F max;
a terminal pressure: the terminal pressure is a pressure within a range of 25% of the terminal of the curve, and the terminal pressure is greater than a theoretical minimum press-fitting force, that is, 75%×Sₙ<Sᵢ≤Sₙ, Fᵢ>F MIN;
a wheelset press-fitting curve characteristic template: the wheelset press-fitting curve characteristic template is constructed according to a length of the wheelset press-fitting curve, a theoretical maximum press-fitting force and a theoretical minimum press-fitting force related to the wheelset to be judged, and the wheelset press-fitting curve should be located in the wheelset press-fitting curve characteristic template;
a step of result display: the relevant information of the judged wheelset, the judgment result of each judgment item and the comprehensive judgment result of the wheelset press-fitting curve are displayed, and the curve graph is displayed, so as to determine whether the wheelset press-fitting curve is qualified or not and to identify the unqualified items; and
a step of applying the judgment result of each judgment item of the wheelset press-fitting curve to adjust the wheelset press-fitting equipment for a subsequent press fitting, so as to ensure the wheelset press-fitting quality and improve the press-fitting efficiency by adjusting the unqualified item to be qualified,
wherein, F max is the actual maximum press-fitting force, MAX(Fi) is a maximum of pressure values at any position i after a starting point on the wheelset press-fitting curve, F MAX is a theoretical maximum press-fitting force, F MIN is a theoretical minimum press-fitting force, F_{f} is the end point pressure, Sᵢ is the relative displacement of the wheel and the axle at position i on the wheelset press-fitting curve, and Fᵢ is the pressure at position i on the wheelset press-fitting curve, Sᵢ₊₁ is the relative displacement of the wheel and the axle at any i+1 position after the i position on the wheelset press-fitting curve, Fᵢ₊₁ is the pressure at any i+1 position after the i position on the wheelset press-fitting curve, Sⱼ is the relative displacement of the wheel and the axle at any j position after the i position on the wheelset press-fitting curve, Fⱼ is the pressure at any j position after the i position on the wheelset press-fitting curve, and Fₙ is the pressure at the end point Sₙ of the wheelset press-fitting curve.

2. The method for analyzing the press-fitting curve of American standard wheelset according to claim 1, wherein for a wheelset with a given press-fitting force range, the theoretical maximum press-fitting force F MAX and the theoretical minimum press-fitting force F MIN are directly set according to the given range; for a wheelset with no given press-fitting force range, a maximum press-fitting force coefficient and a minimum press-fitting force coefficient are set, and then the theoretical maximum press-fitting force F MAX and the theoretical minimum press-fitting force F MIN are calculated according to the maximum and minimum press-fitting force coefficients and a wheel seat diameter.

3. The method for analyzing the press-fitting curve of American standard wheelset according to claim 1, wherein the obtained wheelset parameters comprise a wheelset product model, a theoretical maximum press-fitting force, a theoretical minimum press-fitting force, a wheel seat diameter, a press-fitting direction in which the wheel is pressed on the axle, an axle number and a wheel number.

4. The method for analyzing the press-fitting curve of American standard wheelset according to claim 1, wherein when judging and analyzing the terminal pressure, the pressure within a range of 20%-30% of the terminal of the curve is greater than the theoretical minimum press-fitting force.

5. A system for analyzing the press-fitting curve of American standard wheelset, comprising:
a wheelset press-fitting curve establishing module configured for acquiring American standard wheelset parameters, press-fitting parameters, pressure data and establishing a wheelset press-fitting curve;
a result analysis module configured for analyzing a plurality of judgment items of the established wheelset press-fitting curve, and judging whether the wheelset press-fitting curve meets requirements according to whether each judgment item meets a corresponding preset algorithm; and
a result display module configured for displaying the relevant information of the judged wheelset, the judgment result of each judgment item, the comprehensive judgment result of the wheelset press-fitting curve, and the curve graph, so as to determine whether the wheelset press-fitting curve is qualified or not, identify the unqualified items, and adjust the wheelset press-fitting equipment for a subsequent press fitting, so as to ensure the wheelset press-fitting quality and improve the press-fitting efficiency by adjusting the unqualified item to be qualified.
